(19) United States
(12) Patent Application Publication
(10) Pub. No.: US 2026/0160107 A1
(43) Pub. Date: Jun. 11, 2026

(54) METHOD AND DEVICE FOR CONTROLLING DOOR

(71) Applicants: Hyundai Motor Company, Seoul (KR); Kia Corporation, Seoul (KR)

(72) Inventor: Dokon KIM, Hwaseong-Si (KR)

(21) Appl. No.: 19/381,779

(22) Filed: Nov. 6, 2025

(30) Foreign Application Priority Data
Dec. 6, 2024 (KR) 10-2024-0181004

(51) Int. Cl. E05F 15/40; B60Q 9/00; E05F 15/70

(52) U.S. Cl. CPC E05F 15/40; B60Q 9/00; E05F 15/70; E05Y 2400/54; E05Y 2900/531

(57) ABSTRACT

A method performed by an apparatus of a vehicle may comprise setting an operation mode of a door to an opening mode based on the vehicle reaching a designated location where the door is configured to provide access for an object in the vehicle, obtaining, from a memory of the vehicle, information on a predefined safety space associated with the vehicle, determining, using a sensor and based on the information on the predefined safety space whether a moving entity exists in the predefined safety space, outputting a signal requesting opening of the door based on no moving entity being present and the operation mode being the opening mode, and changing the operation mode to a vehicle stop standby mode after the door is opened.

### CROSS-REFERENCE TO RELATED APPLICATION

This application claims the benefit of priority to Korean Patent Application No. 10-2024-0181004 filed with the Korean Intellectual Property Office on Dec. 6, 2024, the entire contents of which are incorporated herein by reference.

### TECHNICAL FIELD

The disclosure relates to a door control method and a door control device, and more particularly, to a method and a device for controlling a door applicable to an unmanned autonomous driving convenience store.

### BACKGROUND

The matters described in this Background section are only for enhancement of understanding of the background of the disclosure, and should not be taken as acknowledgment that they correspond to prior art already known to those skilled in the art.

An autonomous vehicle is being developed in advance in various regions, and application of an autonomous driving technology to a goods vehicle in particular is becoming increasingly important. An unmanned autonomous driving convenience store may be a mobile convenience store that uses the autonomous driving technology to move by itself without a driver and sell goods. The convenience store may provide shopping convenience by moving to a place desired by a customer. In the unmanned autonomous driving convenience store, a door needs to be closed to protect the goods when it is not on sale, and the door needs to be opened for sale. Collision with people or objects may occur while the door is opened or closed.

### SUMMARY

A problem to be solved by the present disclosure is intended to provide a method and a device for controlling a door capable of preventing collision with people or objects when a door of an unmanned autonomous driving convenience store is opened or closed up and down.

According to the present disclosure, a method performed by an apparatus of a vehicle, the method may comprise based on the vehicle reaching a designated location where the vehicle is configured to open a door of the vehicle to provide access for an object in the vehicle, setting an operation mode of the door to an opening mode, obtaining, from a memory of the vehicle, information on a predefined safety space associated with the vehicle, determining, using a sensor of the vehicle and based on the information on the predefined safety space whether a moving entity exists in the predefined safety space, outputting, based on determining that no moving entity exists in the predefined safety space and the operation mode being the opening mode, a signal requesting opening of the door, and changing, based on the opening of the door being completed, the operation mode of the door to a vehicle stop standby mode, in which the vehicle is configured to remain stationary with the door being opened to allow access to the object in the vehicle.

The method may further comprise detecting, based on data obtained from the sensor, a current driving position of the vehicle, obtaining, based on the current driving position of the vehicle, position information for the designated location from the memory, and determining, based on the current driving position and the position information, whether the vehicle reaches the designated location, wherein the designated location is associated with an item transaction between the vehicle and an entity.

The method may further comprise detecting, based on information on a surrounding environment of the vehicle obtained from the sensor, a predetermined type of object in the surrounding environment, and determining, based on the detecting of the predetermined type of object, that the vehicle reaches the designated location. The method, wherein the information on the predefined safety space may comprise a value representing a radius defined around a point of a service space of the vehicle via which the object in the vehicle is visually displayed on a side surface of the vehicle when the service space is not covered by the door, and wherein the door is configured to open to uncover at least a portion of the service space.

The method, wherein the information on the predefined safety space may comprise values representing a first radius and a second radius, wherein the first radius and the second radius are defined around a point of a service space of the vehicle in which the object in vehicle is displayed, and wherein the determining of whether the moving entity exists in the predefined safety space may comprise based on a first object being located within the first radius and moving at or above a predetermined first speed, determining that the first object is the moving entity, and based on a second object being located within the second radius and moving at or above a predetermined second speed, determining that the second object is the moving entity.

The method, wherein the outputting of the signal may comprise delaying the outputting of the signal until a detected moving entity in the predefined safety space disappears from the safety space. The method may further comprise outputting, based on the operation mode of the door being changed to the opening mode, a warning sound via a speaker of the vehicle or a warning message via an external display of the vehicle, and stopping, based on the operation mode of the door being changed to the vehicle stop standby mode, the outputting of the warning sound or the warning message.

The method may further comprise changing, based on an event indicating the access to the object in the vehicle ending, the operation mode of the door to a closing mode, delaying, based on the operation mode of the door being the closing mode, outputting of a signal requesting closing of the door until a detected moving entity in the predefined safety space disappears from the safety space, outputting, based on the detected moving entity in the predefined safety space disappearing from the safety space, the signal requesting the closing of the door, and changing, based on the closing of the door being completed, the operation mode of the door to a driving mode.

The method may further comprise outputting, based on the operation mode of the door being changed to the closing mode, a warning sound via a speaker of the vehicle or a warning message via an external display device of the vehicle, and stopping, based on the operation mode of the door being changed to the driving mode, outputting of the warning sound or the warning message.

According to the present disclosure, an apparatus of a vehicle, the apparatus may comprise a processor, and a memory storing at least one instruction that, when executed by the processor communicating with the memory, is configured to cause the apparatus to, based on the vehicle reaching a designated location where the vehicle is configured to open a door of the vehicle to provide access to an object in the vehicle, set an operation mode of the door to an opening mode, obtain, from a memory of the vehicle, information on a predefined safety space associated with the vehicle, determine, using a sensor of the vehicle and based on the information on the predefined safety space, whether a moving entity exists in the predefined safety space, output, based on determining that no moving entity exists in the predefined safety space and the operation mode being the opening mode, a signal requesting opening of the door, and changing, based on the opening of the door being completed, the operation mode of the door to a vehicle stop standby mode, in which the vehicle is configured to remain stationary with the door being opened to allow access to the object in the vehicle.

The apparatus, wherein the at least one instruction, when executed by the processor communicating with the memory, is configured to cause the apparatus to detect, based on data obtained from the sensor, a current driving position of the vehicle, obtain, based on the current driving position of the vehicle, position information for the designated location from the memory, and determining, based on the current driving position and the position information, whether the vehicle reaches the designated location, and wherein the designated location is associated with an item transaction between the vehicle and an entity.

The apparatus, wherein the at least one instruction, when executed by the processor communicating with the memory, is configured to cause the apparatus to detect, based on information on a surrounding environment of the vehicle obtained from the sensor, a predetermined type of object in the surrounding environment, and determine, based on the detection of the predetermined type of object, that the vehicle reaches the designated location.

The apparatus, wherein the information on the predefined safety space may comprise a value representing a radius defined around a point of a service space of the vehicle via which the object in vehicle is visually displayed on a side surface of the vehicle when the service space is not covered by the door, and wherein the door is configured to open to uncover at least a portion of the service space.

The apparatus, wherein the information on the predefined safety space may comprise values representing a first radius and a second radius, wherein the first radius and the second radius are defined around a service space of the vehicle in which the object in vehicle is displayed, and wherein the at least one instruction, when executed by the processor communicating with the memory, is configured to cause the apparatus to, based on a first object being located within the first radius and moving at or above a predetermined first speed, determine that the first object is the moving entity, and based on the second object being located within the second radius and moving at or above a predetermined second speed, determine that the second object is the moving entity. The apparatus, wherein a shock absorbing material is formed at at least one corner of the door.

According to the present disclosure, an autonomous vehicle may comprise a service compartment configured to accommodate and present an object for retrieval, a door movably mounted to a side of the autonomous vehicle and configured to open to allow an access to the service compartment, at least one sensor configured to detect a presence of an external entity in a predefined safety space within a threshold distance from the door, and a processor circuit configured to determine whether the autonomous vehicle has reached a designated location associated with at least one operation of the service compartment, detect, using the at least one sensor and based on the autonomous vehicle reaching the designated location, whether an external entity is present in the predefined safety space, deactivate, based on a detection of the external entity in the predefined safety space, movement of the door, and activate, based on the external entity not being present in the predefined safety space, movement of the door to cause opening of the door to allow access to the service compartment or cause closing of the door to prevent access to the service compartment.

The autonomous vehicle, wherein the door is configured to open and close via a hinge disposed along an upper edge of the door, such that the door moves in a vertical direction relative to the autonomous vehicle. The autonomous vehicle, wherein the processor circuit is further configured to output, based on a detection of the external entity in the predefined safety space, a warning signal to at least one of an external display of the autonomous vehicle or an audio output device of the autonomous vehicle.

The autonomous vehicle, wherein the designated location is a stop point associated with the retrieval of the object in the service compartment. The autonomous vehicle, wherein the predefined safety space may comprise a first area within a first radius from the door and a second area within a second radius from the door, the second radius being greater than the first radius, and wherein the processor circuit is further configured to determine that the external entity is present in the predefined safety space by identifying, as the external entity, a first object located within the first radius and moving at or above a first threshold speed, and identifying, as the external entity, a second object located within the second radius and moving at or above a second threshold speed, wherein the second threshold speed is greater than the first threshold speed.

### BRIEF DESCRIPTION OF THE DRAWINGS

FIG. 1 shows an example of a device for controlling a door according to an example.

FIG. 2 shows an example of an unmanned autonomous driving convenience store according to an example.

FIG. 3 shows an example of an unmanned autonomous driving convenience store according to an example.

FIG. 4 shows an example of a method for controlling a door according to an example.

FIG. 5 shows an example of a method for controlling a door according to an example.

FIG. 6 shows an example of a method for controlling a door according to an example.

FIG. 7 shows an example of a computing device according to an example.

### DETAILED DESCRIPTION

Examples of the present disclosure will be described more fully hereinafter with reference to the accompanying drawings so that those skilled in the art could easily implement the examples. The present disclosure may be modified in various ways, all without departing from the spirit or scope of the present disclosure. In order to clearly describe the present disclosure, parts or portions that are irrelevant to the description are omitted, and identical or similar constituent elements throughout the specification are denoted by the same reference numerals.

Unless explicitly stated to the contrary, the word “comprise” and variations such as “comprises” and “comprising” in the specification and claims should be understood to imply the inclusion of stated elements but not the exclusion of any other elements. In the present disclosure, terms including ordinal numbers such as “first” and “second” may be used to describe various constituent elements, but the constituent elements are not limited by the terms. The terms may be used for a purpose of distinguishing one constituent element from other constituent elements.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

A term such as “portion,” “~er/or”, or “module” described in the specification may refer to a unit capable of processing at least one function or operation described in the specification, and the unit capable of processing at least one function or operation may be implemented by hardware (or a circuit), software, or a combination of hardware (or a circuit) and software. At least some configurations or functions of a method and a device for controlling a door applicable to an unmanned autonomous driving convenience store according to examples described below may be implemented as a program or software, and the program or the software may be stored in a computer-readable recording medium or storage medium.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., feature of controlling a door of the vehicle) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., feature of controlling a door of the vehicle) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., feature of controlling a door of the vehicle) described herein.

Minimum risk maneuver (MRM) operation(s) may also be controlled, for example, based on one or more features (e.g., feature of controlling a door of the vehicle) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., feature of controlling a door of the vehicle) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., feature of controlling a door of the vehicle) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

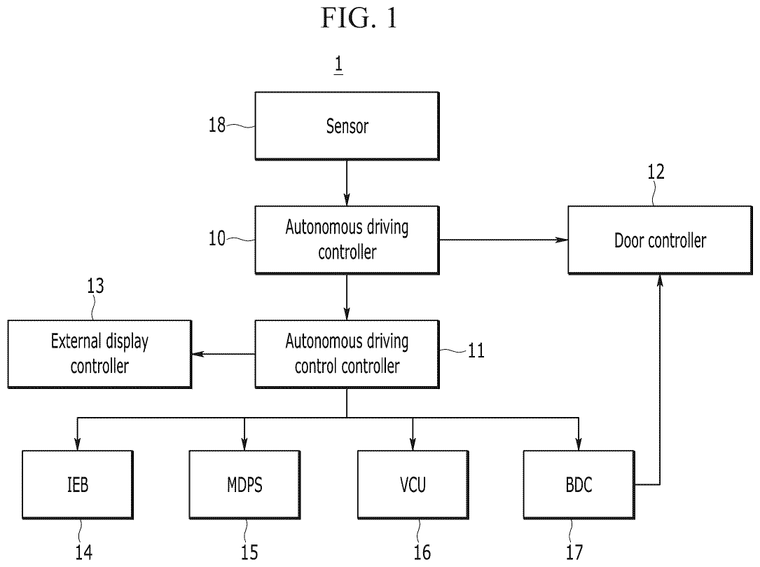

FIG. 1 shows an example of a device for controlling a door according to an example.

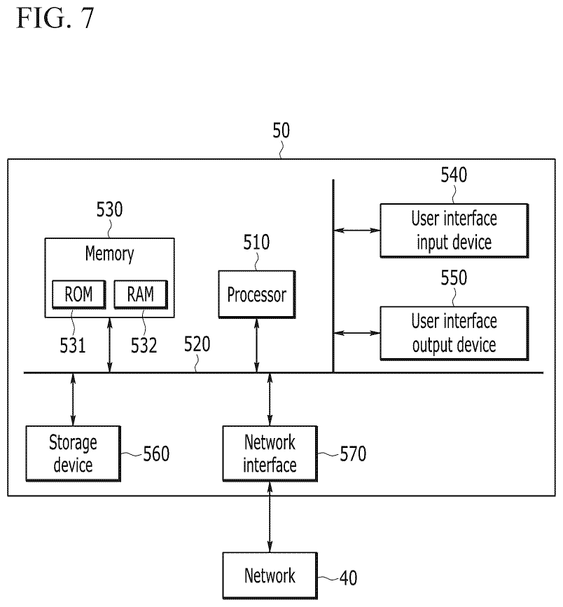

Referring to FIG. 1, the device for controlling the door according to the example may be implemented as a computing device including a processor and a memory. For example, the door control device 10 may be implemented as a computing device 50 described below with reference to FIG. 7. The computing device 50 may be a device implemented in a vehicle 1 (e.g., an autonomous driving controller 10 mounted on the vehicle 1, a mobile vending vehicle, or a last-mile delivery robot, etc.). In this case, the processor may correspond to a processor 510 of the computing device 50, and the memory may correspond to a memory 530 of the computing device 50. Alternatively, in some examples, the autonomous driving controller 10 may include one or more non-transitory computer-readable media including an instruction and one or more processors that execute the instruction to perform an operation (e.g., sensor data processing, object detection, or motion control, etc.). The operation may include a configuration, a function, a step, or other control logic described in the present specification regarding a door control method and a door control device according to examples (e.g., sensing, decision-making, signaling, or outputting, etc.). In the present specification, the term “module” is used to logically distinguish operations performed by the door control method and the door control device according to the examples (e.g., detecting nearby objects, evaluating safety zones, controlling door motion, or generating alerts, etc.). An autonomous driving control controller 11, a door controller 12, an external display controller 13, and other vehicle controllers 14, 15, 16, and 17 (e.g., for braking, steering, propulsion, or body control, etc.) may also be implemented as the computing device 50. The term “unmanned autonomous driving convenience store 1” used in the present specification may be a concept that includes a goods vehicle (e.g., a mobile vending truck, a robotic delivery van, or a self-driving retail kiosk, etc.). Hereinafter, the unmanned autonomous driving convenience store 1 will also be briefly referred to as a vehicle.

The autonomous driving controller 10 may be a device that plays a key role in performing an autonomous driving function within the vehicle, and may collect sensor data of the vehicle in real time and may analyze the collected data to perform determination, such as setting a driving path, controlling vehicle speed, or avoiding an obstacle (e.g., a pedestrian, a parked bicycle, or a road sign, etc.). In particular, the autonomous driving controller 10 may detect a person or an object within a target range in relation to opening and closing of the door (e.g., within 1-3 meters of the vehicle side, directly beneath the door, or approaching from the rear, etc.), and may exchange information with the autonomous driving control controller 11 to determine whether a door opening/closing command is executed based on the detected person or object. The autonomous driving control controller 11 may be a system that comprehensively determines a situation outside the vehicle and manages a control command (e.g., alert generation, door actuation, or vehicle pausing, etc.), and may execute a command such as outputting a warning sound or displaying a display warning screen based on data received from the autonomous driving controller 10. The autonomous driving control controller 11 may analyze a traffic situation around the vehicle, obstacle information, a door opening/closing situation, and the like to detect a dangerous situation in advance and control an operation of the vehicle to properly cope with the dangerous situation (e.g., temporarily halting door operation, pausing movement, or activating visual alerts, etc.). For example, the autonomous driving control controller 11 may transmit a control command to vehicle controllers such as an integrated electric booster (IEB) 14, a motor-driven power steering (MDPS) 15, a vehicle control unit (VCU) 16, and a body domain controller (BDC) 17 (e.g., to apply braking, adjust steering angle, control acceleration, or manage lighting and display functions, etc.).

The unmanned autonomous driving convenience store 1 (that is, the vehicle) may include a service area 21 defined as a space in which goods are displayed on one side surface thereof (e.g., shelves, vending compartments, or refrigerated units, etc.), and a door 20 that is opened or closed up and down through a hinge provided on an upper surface thereof to open or close the service area 21. If it is determined that the vehicle stops to reach a sale area for selling the goods (e.g., a designated parking zone, a curbside location, or a customer-defined waypoint, etc.), the autonomous driving controller 10 may set an operation mode of the door 20 to an opening mode. Even if the operation mode of the door 20 is set to the opening mode, the door 20 may not be immediately opened until safety conditions are satisfied. In some examples, payment equipment (e.g., a touchscreen terminal, QR code scanner, or contactless reader, etc.) may be disposed in the service area.

In some examples, the autonomous driving controller 10 may detect a current driving position of the vehicle 1 through a position detection device (e.g., a global positioning system (GPS), an inertial navigation system, or a cellular triangulation system, etc.), and may read position information for a predefined sale area from the memory. The autonomous driving controller 10 may determine whether the vehicle 1 reaches the sale area based on the detected current driving position and the position information for the predetermined sale area.

In some examples, the autonomous driving controller 10 may recognize a surrounding environment (e.g., a road marking, a curb structure, or a posted instruction sign, etc.) through a sensor 18 to detect a predetermined type of object in the surrounding environment, and may determine that the vehicle 1 reaches the sale area if the predetermined type of object is detected. The predetermined type of object may include a parking lane indicating the sale area and a sign indicating the sale area (e.g., a painted rectangle, a branded flag, or a directional placard, etc.). For example, the autonomous driving controller 10 may capture image data through the sensor 18, and may process the captured data with a computer vision algorithm to analyze a characteristic such as a color, a shape, or a text (e.g., a lane boundary, a directional arrow, or a sale-area label, etc.) of each of the lane and the sign. For example, if the collected sensor data are analyzed through a deep learning-based object detection model and both the parking lane indicating the sale area and the sign indicating the sale area (e.g., a “stop here” marking, a customer pickup zone label, or a colored boundary line, etc.) are detected, the autonomous driving controller 10 may determine that the vehicle 1 reaches the sale area.

In some examples, the autonomous driving controller 10 may determine that the vehicle 1 reaches the sale area if the current driving position primarily detected is included in a position for the predetermined sale area and the predetermined type of object is detected in a surrounding environment recognized in the current driving position secondarily detected (e.g., through camera-based detection, LiDAR contour mapping, or radar reflection patterns, etc.).

The autonomous driving controller 10 may read information on a predefined safety area from the memory after setting the operation mode of the door 20 to the opening mode. The information on the safety area may include a value representing a radius determined around the service area 21. For example, the information on the safety area may include a numerical value of an area corresponding to a radius of 3 m around the service area 21 (e.g., a circular buffer zone centered on the door or a dynamic exclusion zone computed in real time, etc.). The autonomous driving controller 10 may determine whether a moving object exists in the safety area by operating the sensor 18 mounted on the vehicle based on the information on the safety area. That is, the autonomous driving controller 10 may operate the sensor 18 mounted on the vehicle to determine whether the moving object exists in the area corresponding to the radius of 3 m around the service area 21 (e.g., a pedestrian, a child on a scooter, or a delivery cart, etc.).

In some examples, the information on the safety area may be determined on a more detailed criterion. For example, the information on the safety area may include values representing a first radius and a second radius determined around the service area 21 (e.g., to distinguish between immediate proximity and high-speed approach zones, etc.). In some examples, the information on the safety area may include a numerical value of a first area corresponding to a radius of 3 m around the service area 21 and a numerical value of a second area corresponding to a radius of 10 m around the service area 21 (e.g., an inner buffer for pedestrians and an outer buffer for fast-approaching bicycles or scooters, etc.). The autonomous driving controller 10 may determine whether the moving object exists in the safety area by operating the sensor 18 mounted on the vehicle based on the information on the safety area. That is, the autonomous driving controller 10 may operate the sensor 18 mounted on the vehicle to determine whether the moving object exists in the first area corresponding to the radius of 3 m around the service area 21 and the second area corresponding to the radius of 10 m around the service area 21 (e.g., using a combination of LiDAR range gates, camera zones, or radar thresholds, etc.).

For example, the autonomous driving controller 10 may determine an object moving at a predetermined first speed or more in the first radius as the moving object (e.g., a walking person or slowly approaching stroller, etc.), and may not determine an object moving at a speed less than the first speed as the moving object. In addition, the autonomous driving controller 10 may determine an object moving at a predetermined second speed or more in the second radius as the moving object (e.g., a fast-moving bicycle, scooter, or skateboard, etc.), and may not determine an object moving at a speed less than the second speed as the moving object. For example, the autonomous driving controller 10 may determine an object moving at a speed of 0.1 km/h or more in the first area with a radius of 3 m as the moving object (e.g., a person walking slowly near the door or a shopping cart being pushed nearby, etc.), and may not determine an object moving at a speed less than 0.1 km/h as the moving object. In addition, the autonomous driving controller 10 may determine an object moving at a predetermined speed of 20 km/h or more in the second area with a radius of 10 m as the moving object (e.g., an electric scooter, bicycle, or delivery robot approaching rapidly, etc.), and may not determine an object moving at a speed less than 20 km/h as the moving object. The moving object may be determined according to the detailed criterion so that precision of control of the door for preventing risk of collision is further increased (e.g., by dynamically adjusting thresholds based on object speed, distance, or trajectory, etc.).

If the operation mode is the opening mode and it is determined that the moving object does not exist in the safety area, the autonomous driving controller 10 may transmit a door opening command requesting opening of the door 20 to the door controller 12. The door controller 12 may open the door 20 in response to the door opening command (e.g., by actuating a motorized hinge or lift mechanism, etc.). The autonomous driving controller 10 may set the operation mode of the door 20 to a vehicle stop standby mode if the opening of the door 20 is completed. In the vehicle stop standby mode, sales activities (e.g., sales of goods) may occur (e.g., product browsing, self-checkout, or payment processing, etc.).

In some examples, if the operation mode of the door 20 is set to the opening mode, the autonomous driving controller 10 may transmit a warning sound (e.g., a beeping alert, a synthesized voice message, or an escalating tone, etc.), or may display a warning on an external display device mounted on the vehicle 1 (e.g., a flashing icon, a text message, or a dynamic animation, etc.). If the operation mode of the door 20 is set to the vehicle stop standby mode, the autonomous driving controller 10 may stop transmitting the warning sound or displaying the warning (e.g., by deactivating the speaker and clearing the external display screen, etc.).

If the operation mode is the opening mode and it is determined that the moving object exists in the safety area, the autonomous driving controller 10 may hold the transmission of the door opening command until the moving object is not detected in the safety area (e.g., by continuously monitoring the zone and rechecking at predefined time intervals, etc.).

If an event indicating that sale of the goods ends occurs (e.g., a timeout, user input, or completion of a transaction, etc.), the autonomous driving controller 10 may set the operation mode of the door 20 to a closing mode. If the operation mode is the closing mode and it is determined that the moving object exists in the safety area (e.g., a lingering customer or approaching scooter, etc.), the autonomous driving controller 10 may hold transmission of a door closing command until the moving object is not detected in the safety area. If the operation mode is the closing mode and it is determined that the moving object does not exist in the safety area, the autonomous driving controller 10 may transmit the door closing command requesting closing of the door 20 to the door controller 12 (e.g., by activating a motorized actuator or servo mechanism, etc.). The door controller 12 may close the door 20 in response to the door closing command. (e.g., by engaging a powered actuator or locking mechanism, etc.) The autonomous driving controller 10 may set the operation mode of the door 20 to a driving mode if the closing of the door 20 is completed. In the driving mode, the vehicle 1 may move (e.g., resume autonomous navigation to the next location, return to a depot, or begin recharging, etc.).

In some examples, if the operation mode of the door 20 is set to the closing mode, the autonomous driving controller 10 may transmit a warning sound (e.g., a buzzer, chime, or verbal countdown, etc.), or may display a warning on an external display device mounted on the vehicle 1 (e.g., a flashing symbol, caution text, or animated icon, etc.). If the operation mode of the door 20 is set to the driving mode, the autonomous driving controller 10 may stop transmitting the warning sound or displaying the warning (e.g., by muting the speaker and clearing visual alerts, etc.).

The present example may provide various advantages and effects of increasing safety and efficiency when the door is opened or closed in the goods vehicle and the unmanned autonomous driving convenience store (e.g., by minimizing human intervention, reducing collision incidents, or enabling smoother customer interactions, etc.). For example, when the door of the goods vehicle moves up and down, the goods vehicle may inform people around the goods vehicle of danger through a warning sound, and may prevent collision with the door for people using last-mile mobility such as an electric kick board or an electric bicycle (e.g., rental scooters, foldable e-bikes, or hoverboards, etc.) through a warning sound and a warning phrase on an external display. In addition, if the autonomous driving controller detects a person or a moving object in a process in which an autonomous vehicle such as the unmanned autonomous driving convenience store opens or closes the door, the door opening/closing command may not be executed until the object is out of the detection range (e.g., when the object moves beyond a 3-meter zone or its speed falls below a threshold, etc.) so that a risk of collision is prevented in advance. In addition, the warning system according to an example may output a warning sound only by modifying an existing logic and adding some signals without additional components, and may increase cost-effectiveness by outputting a warning screen using a display installed for an external advertisement (e.g., digital signage or promotional panel, etc.). The system may be applied not only to the unmanned autonomous driving convenience store but also to the goods vehicle that closes the door up and down to effectively prevent a collision accident (e.g., refrigerated trucks, parcel lockers, or service kiosks, etc.).

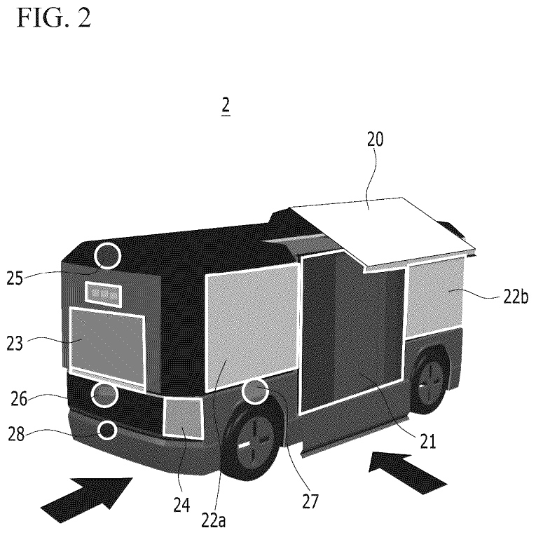

FIG. 2 shows an example of the unmanned autonomous driving convenience store according to an example.

Referring to FIG. 2, an unmanned autonomous driving convenience store 2 according to an example may include the door 20, each of service areas 21, 22a, and 22b, an external display 23, a light emitting device 24, a long-range LiDAR 25, each of short-range LiDARs 26 and 27, and a radar 28 (e.g., for 360-degree object detection, lane positioning, or collision avoidance, etc.).

The door 20 may be opened or closed up and down through a hinge provided on an upper surface thereof to open or close the service area 21. Goods may be displayed and payment equipment may be disposed in the service area 21 (e.g., shelves with snacks, a digital payment terminal, or a product scanner, etc.), and for example, a microwave oven may be disposed in the service areas 22a and 22b to cook food on the spot (e.g., heating instant noodles or ready-to-eat meals, etc.). The external display 23 may display a warning when the operation mode of the door 20 is set to the opening mode or the closing mode, or may display contents related to sale of the goods (e.g., promotional videos, menus, or payment instructions, etc.). The light emitting device 24 may be mounted to implement an appropriate light emitting effect (e.g., blinking patterns, directional lighting, or color-coded status indicators, etc.). The long-range LiDAR 25 may be used to detect a moving object moving at high speeds (e.g., an approaching bicycle or scooter, etc.), and each of the short-range LiDARs 26 and 27 may be used to detect a moving object moving close to the vehicle 1 (e.g., a pedestrian or shopping cart, etc.). Although not clearly shown in the drawings, a sound generating device and a camera device may be mounted on the vehicle 1 (e.g., a speaker for audible alerts or a fisheye camera for wide-angle monitoring, etc.).

If it is determined that the vehicle stops to reach the sale area for selling the goods, the operation mode of the door 20 may be set to the opening mode, and sensors such as the long-range LiDAR 25, each of the short-range LiDARs 26 and 27, and the radar 28 may be operated based on information on the safety area so that whether the moving object exists in the safety area is determined (e.g., by scanning for pedestrians, bicycles, or scooters within a defined perimeter, etc.). If the operation mode is the opening mode and it is determined that the moving object does not exist in the safety area, the door opening command requesting opening of the door 20 may be transmitted to the door controller 12. If the opening of the door 20 is completed, the operation mode of the door 20 may be set to the vehicle stop standby mode (e.g., to allow customer interaction or automated vending, etc.).

If an event indicating that sale of the goods ends occurs (e.g., a timer expiration, user departure, or completion of all transactions, etc.), the operation mode of the door 20 is set to the closing mode, and it is determined that the moving object exists in the safety area, transmission of the door closing command may be held until the moving object is not detected in the safety area (e.g., to avoid collisions with approaching objects, etc.). If the operation mode is the closing mode and it is determined that the moving object does not exist in the safety area, the door closing command requesting closing of the door 20 may be transmitted to the door controller 12. If the closing of the door 20 is completed, the operation mode of the door 20 may be set to the driving mode (e.g., enabling the vehicle to resume autonomous navigation to the next location, etc.).

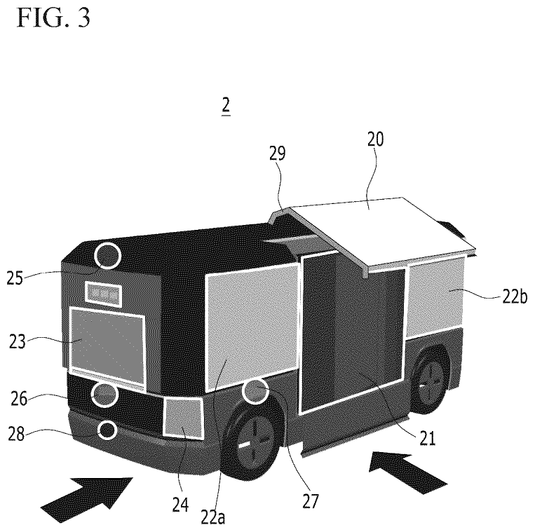

FIG. 3 shows an example of the unmanned autonomous driving convenience store according to an example.

Referring to FIG. 3, an unmanned autonomous driving convenience store 2 according to an example may include the door 20, each of service areas 21, 22a, and 22b, an external display 23, a light emitting device 24, a long-range LiDAR 25, each of short-range LiDARs 26 and 27, and a radar 28 e.g., for detecting surrounding obstacles, dynamic objects, or approaching users, etc.).

A difference between the example of FIG. 3 and the example of FIG. 2 is that a shock absorbing material 29 is formed at at least one corner of the door 20 (e.g., the lower outer edge or hinge joint area, etc.). In order to alleviate a shock that may occur when mobility such as an electric kick board or an electric bicycle (e.g., shared e-scooters, folding bikes, or hoverboards, etc.) approaches the door 20 at a high speed to collide with the door 20, the shock absorbing material 29 may be applied to at least one corner of the door 20. In some examples, the shock absorbing material 29 may be made of a polyurethane material, and may be replaced with a rubber material if necessary (e.g., depending on environmental durability or cost considerations, etc.). Basically, the door may be set not to be opened or closed if the electric kick board or the electric bicycle approaches the door, but safety may be enhanced by adding the shock absorbing material 29 in preparation for a situation in which the electric kick board or the electric bicycle approaches the door at a high speed outside a target point range (e.g., when sensors fail to detect early or approach speed exceeds prediction thresholds, etc.).

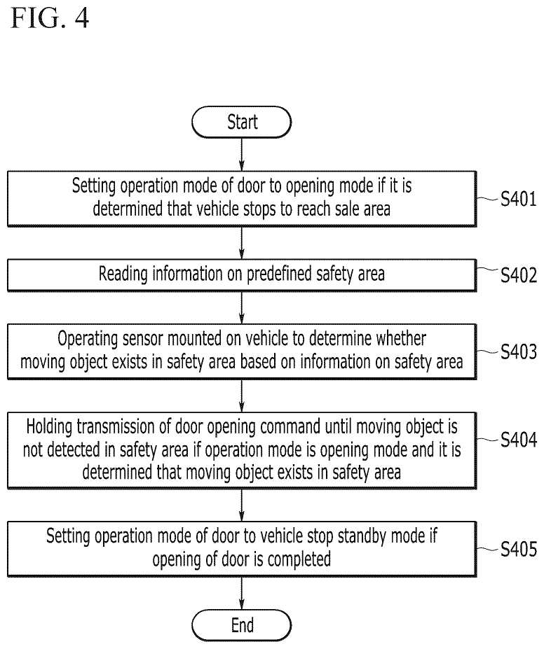

FIG. 4 shows an example of a method for controlling the door according to an example.

Referring to FIG. 4, in the door control method according to the example, a step S401 of setting the operation mode of the door to the opening mode if it is determined that the vehicle stops to reach the sale area (e.g., a predefined vending location or customer-designated stop, etc.), a step S402 of reading information on the predefined safety area (e.g., a 3-meter or 10-meter radius around the door, etc.), a step S403 of operating the sensor mounted on the vehicle to determine whether the moving object exists in the safety area based on the information on the safety area (e.g., using LiDAR, radar, or camera input, etc.), a step S404 of holding transmission of the door opening command until the moving object is not detected in the safety area if the operation mode is the opening mode and it is determined that the moving object exists in the safety area (e.g., a nearby pedestrian, cyclist, or shopping cart, etc.), and a step S405 of setting the operation mode of the door to the vehicle stop standby mode if opening of the door is completed (e.g., enabling customer access to the goods or services, etc.) may be performed.

Because descriptions of the examples of the present specification are applied to more detailed descriptions of the method, a redundant description thereof will be omitted.

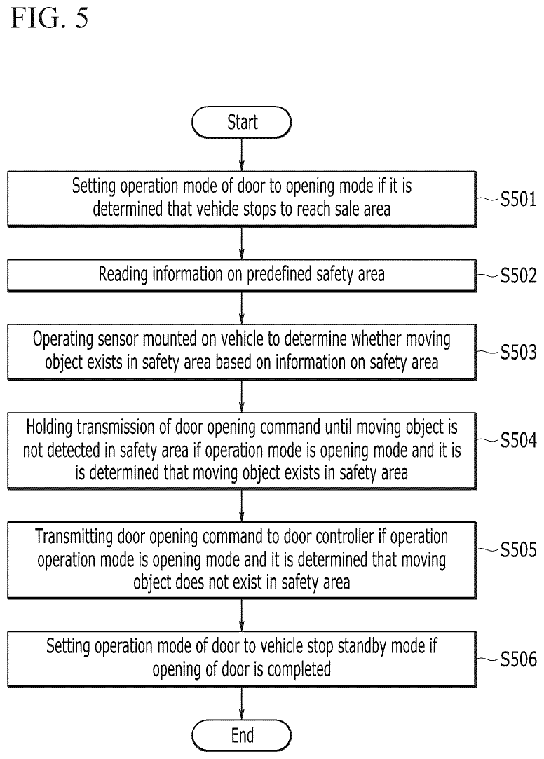

FIG. 5 shows an example of a method for controlling the door according to an example.

Referring to FIG. 5, in the door control method according to the example, a step S501 of setting the operation mode of the door to the opening mode if it is determined that the vehicle stops to reach the sale area (e.g., based on GPS location or visual marker detection, etc.), a step S502 of reading information on the predefined safety area (e.g., stored threshold distances and speed conditions, etc.), a step S503 of operating the sensor mounted on the vehicle to determine whether the moving object exists in the safety area based on the information on the safety area (e.g., checking for moving objects using fused LiDAR and camera data, etc.), a step S504 of holding transmission of the door opening command until the moving object is not detected in the safety area if the operation mode is the opening mode and it is determined that the moving object exists in the safety area (e.g., a child on a scooter or a person walking a dog, etc.), a step S505 of transmitting the door opening command to the door controller if the operation mode is the opening mode and it is determined that the moving object does not exist in the safety area (e.g., after a clearing delay or validation sweep, etc.), and a step S506 of setting the operation mode of the door to the vehicle stop standby mode, if opening of the door is completed (e.g., ready for sales interaction or item pickup, etc.), may be performed.

Because descriptions of the examples of the present specification are applied to more detailed descriptions of the method, a redundant description thereof will be omitted.

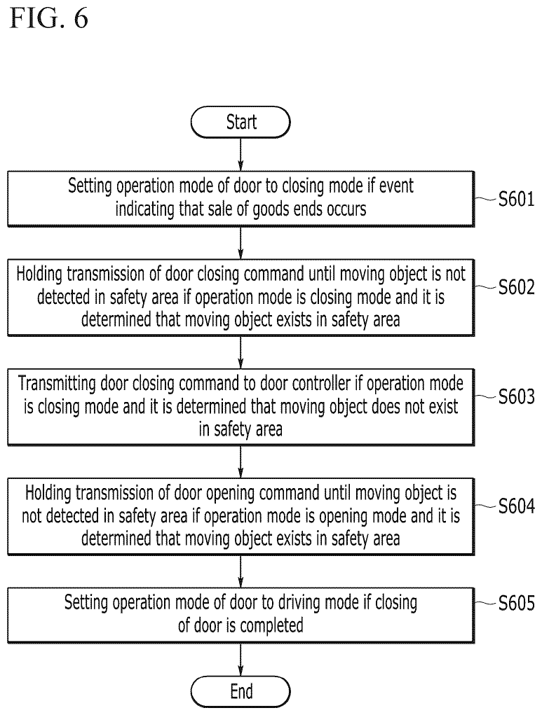

FIG. 6 shows an example of a method for controlling the door according to an example.

Referring to FIG. 6, in the door control method according to the example, a step S601 of setting the operation mode of the door to the closing mode if an event indicating that sale of the goods ends occurs (e.g., a transaction timeout, item retrieval completion, or user departure, etc.), a step S602 of holding transmission of the door closing command until the moving object is not detected in the safety area if the operation mode is the closing mode and it is determined that the moving object exists in the safety area (e.g., a customer lingering nearby or a delivery vehicle passing close, etc.), a step S603 of transmitting the door closing command to the door controller if the operation mode is the closing mode and it is determined that the moving object does not exist in the safety area (e.g., after a sensor sweep confirms clearance, etc.), a step S604 of holding transmission of the door opening command until the moving object is not detected in the safety area if the operation mode is the opening mode and it is determined that the moving object exists in the safety area (e.g., due to unexpected object re-entry or crowd formation, etc.), and a step S605 of setting the operation mode of the door to the driving mode if closing of the door is completed (e.g., enabling autonomous departure to a next delivery point or return location, etc.) may be performed.

Because descriptions of the examples of the present specification are applied to more detailed descriptions of the method, a redundant description thereof will be omitted.

FIG. 7 shows an example of the computing device according to an example.

Referring to FIG. 7, the door control method and the door control device according to the examples may be implemented using the computing device 50. The computing device 50 may be implemented as various types of electronic devices, servers, or similar devices (e.g., embedded control boards, automotive-grade edge processors, or industrial microcomputers, etc.), and its function may be implemented through a combination of software and hardware (e.g., real-time operating systems and sensor interfacing circuits, etc.).

The computing device 50 may include at least one of the processor 510, the memory 530, a user interface input device 540, a user interface output device 550, and a storage device 560 that communicate through a bus 520 (e.g., a system-on-chip architecture or modular controller framework, etc.). The computing device 50 may also include a network interface 570 electrically connected to a network 40. The network interface 570 may transmit or receive a signal with another entity via the network 40 (e.g., a remote server, cloud-based management system, or fleet control center, etc.).

The processor 510 may be implemented as various types of computing devices such as a microcontroller unit (MCU), an application processor (AP), a central processing unit (CPU), a graphics processing unit (GPU), a neural processing unit (NPU), and a quantum processing unit (QPU) (e.g., depending on the required processing speed, energy efficiency, or AI workload, etc.). The processor 510 may be a semiconductor device that executes a command stored in the memory 530 or the storage device 560, and may perform a key role in controlling sensors, executing logic, and managing communication across the system. A program code and data stored in the memory 530 or the storage device 560 may instruct the processor 510 to perform a specific task, so that it enables an overall operation of the system (e.g., door actuation, safety checking, or interface updates, etc.). The processor 510 may be configured to implement various functions and the methods described above with respect to FIGS. 1 to 6.

The memory 530 and the storage device 560 may include various types of volatile or non-volatile storage media for storing and accessing data of the system (e.g., operating parameters, detection thresholds, or system logs, etc.). For example, the memory 530 may include a read-only memory (ROM) 531 and a random access memory (RAM) 532 (e.g., DRAM or SRAM, etc.). In some examples, the memory 530 may be embedded inside the processor 510, and in this case, a data transmission speed between the memory 530 and the processor 510 may be very fast (e.g., via on-die cache or tightly coupled memory, etc.). In some examples, the memory 530 may be disposed outside the processor 510, and in this case, the memory 530 may be connected to the processor 510 through various data buses or interfaces (e.g., LPDDR, SPI, or I²C, etc.). The connection may be made through a variety of already known means such as a peripheral component interconnect express (PCIe) interface or a memory controller for high-speed data transmission (e.g., to enable rapid access to high-resolution sensor inputs or neural network weights, etc.).

In some examples, at least some components or functions of the door control method and device according to the examples may be implemented as a program or software executed in the computing device 50, and the program or software may be stored in a computer-readable recording medium or storage medium (e.g., flash memory, SSD, or embedded eMMC, etc.). For example, the computer-readable recording medium or storage medium according to an example may be a medium in which a program for executing steps included in implementation of the door control method and device according to the examples is recorded in a computer including the processor 510 executing a program or a command stored in the memory 530 or the storage device 560 (e.g., to handle sensor fusion, object classification, or door actuation logic, etc.).

In some examples, at least some components or functions of the door control method and device according to the examples may be implemented using hardware or a circuit of the computing device 50, or may be implemented as separate hardware or a separate circuit capable of being electrically connected to the computing device 50 (e.g., an FPGA module, a dedicated motor driver IC, or a safety watchdog timer circuit, etc.).

In some examples, one or more non-transitory computer-readable media including an instruction that may be executed by the computing device 50 may be provided, and the instruction may cause the computing device 50 to perform an operation when executed by one or more processors of the computing device 50. The operation may include a configuration, a function, a step, or the like described in the present specification with respect to the door control method and device according to the examples (e.g., determining door mode based on GPS location, detecting nearby moving objects, issuing a door control command, or activating a visual/audio warning, etc.).

The examples may provide various advantages and effects in terms of increasing safety and efficiency when the door is opened or closed in the goods vehicle and the unmanned autonomous driving convenience store (e.g., reducing human error, improving reaction timing, or minimizing mechanical wear, etc.). For example, when the door of the goods vehicle moves up and down, the goods vehicle may inform people around the goods vehicle of danger through a warning sound, and may prevent collision with the door for people using last-mile mobility such as an electric kick board or an electric bicycle through a warning sound and a warning phrase on an external display (e.g., “Caution: Door Opening,” “Please Stand Back,” or flashing icons, etc.). In addition, if the autonomous driving controller detects a person or a moving object in a process in which an autonomous vehicle such as the unmanned autonomous driving convenience store opens or closes the door, the door opening/closing command may not be executed until the object is out of the detection range so that a risk of collision is prevented in advance (e.g., by delaying actuation or issuing repeated warnings, etc.). In addition, the warning system according to an example may output a warning sound only by modifying an existing logic and adding some signals without additional components, and may increase cost-effectiveness by outputting a warning screen using a display installed for an external advertisement (e.g., LED signage or LCD panels, etc.). The system may be applied not only to the unmanned autonomous driving convenience store but also to the goods vehicle that closes the door up and down to effectively prevent a collision accident (e.g., during roadside sales, vending, or logistics delivery operations, etc.).

A method for controlling a door that is implemented in a vehicle including a service area defined as a space where goods are displayed on one side surface thereof and a door that is opened or closed up and down through a hinge provided on an upper surface thereof to open or close the service area and is performed on a computing device including a processor and a memory according to an example of the present disclosure includes: setting, by the processor, an operation mode of the door to an opening mode if it is determined that the vehicle stops to reach a sale area selling the goods; reading, by the processor, information on a predefined safety area from the memory; operating, by the processor, a sensor mounted on the vehicle to determine whether a moving object exists in the safety area based on the information on the safety area; transmitting, by the processor, a door opening command requesting opening of the door to a door controller if the operation mode is the opening mode and it is determined that the moving object does not exist in the safety area; and setting, by the processor, the operation mode of the door to a vehicle stop standby mode if the opening of the door is completed.

The method may further include: detecting, by the processor, a current driving position of the vehicle through a position detection device; reading, by the processor, position information for a predefined sale area from the memory; and determining, by the processor, whether the vehicle reaches the sale area based on the current driving position and the position information.

The method may further include: recognizing, by the processor, a surrounding environment through the sensor to detect a predetermined type of object in the surrounding environment; and determining, by the processor, that the vehicle reaches the sale area if the predetermined type of object is detected.

The information on the safety area may include a value representing a radius determined around the service area.

The information on the safety area may include values representing a first radius and a second radius determined around the service area, and the determining of whether the moving object exists in the safety area may include determining an object moving at a predetermined first speed or more in the first radius as the moving object and determining an object moving at a predetermined second speed or more in the second radius as the moving object.

The method may further include holding, by the processor, transmission of the door opening command until the moving object is not detected in the safety area if the operation mode is the opening mode and it is determined that the moving object exists in the safety area.

The method may further include: transmitting, by the processor, a warning sound or displaying, by the processor, a warning on an external display device mounted on the vehicle if the operation mode of the door is set to the opening mode; and stopping, by the processor, transmission of the warning sound or display of the warning if the operation mode of the door is set to the vehicle stop standby mode.

The method may further include: setting, by the processor, the operation mode of the door to a closing mode if an event indicating that sale of the goods ends occurs; holding, by the processor, transmission of a door closing command until the moving object is not detected in the safety area if the operation mode is the closing mode and it is determined that the moving object exists in the safety area; transmitting, by the processor, the door closing command requesting closing of the door to the door controller if the operation mode is the closing mode and it is determined that the moving object does not exist in the safety area; and setting, by the processor, the operation mode of the door to a driving mode if the closing of the door is completed.

The method may further include: transmitting, by the processor, a warning sound or displaying, by the processor, a warning on an external display device mounted on the vehicle if the operation mode of the door is set to the closing mode; and stopping, by the processor, transmission of the warning sound or display of the warning if the operation mode of the door is set to the driving mode.

A device for controlling a door that is implemented in a vehicle including a service area defined as a space where goods are displayed on one side surface thereof and a door that is opened or closed up and down through a hinge provided on an upper surface thereof to open or close the service area according to an example includes: one or more non-transitory computer-readable media that include an instruction; and one or more processors that execute the instruction to perform an operation. The operation includes: setting an operation mode of the door to an opening mode if it is determined that the vehicle stops to reach a sale area selling the goods; reading information on a predefined safety area from the computer-readable medium; operating a sensor mounted on the vehicle to determine whether a moving object exists in the safety area based on the information on the safety area; transmitting a door opening command requesting opening of the door to a door controller if the operation mode is the opening mode and it is determined that the moving object does not exist in the safety area; and setting the operation mode of the door to a vehicle stop standby mode if the opening of the door is completed.

The operation may include: detecting a current driving position of the vehicle through a position detection device; reading position information for a predefined sale area from the computer-readable medium; and determining whether the vehicle reaches the sale area based on the current driving position and the position information.

The operation may further include: recognizing a surrounding environment through the sensor to detect a predetermined type of object in the surrounding environment; and determining that the vehicle reaches the sale area if the predetermined type of object is detected.

The information on the safety area may include a value representing a radius determined around the service area.

The information on the safety area may include values representing a first radius and a second radius determined around the service area, and the determining of whether the moving object exists in the safety area may include determining an object moving at a predetermined first speed or more in the first radius as the moving object and determining an object moving at a predetermined second speed or more in the second radius as the moving object.

The operation may further include holding transmission of the door opening command until the moving object is not detected in the safety area if the operation mode is the opening mode and it is determined that the moving object exists in the safety area.

The operation may further include: transmitting a warning sound or displaying a warning on an external display device mounted on the vehicle if the operation mode of the door is set to the opening mode; and stopping transmission of the warning sound or display of the warning if the operation mode of the door is set to the vehicle stop standby mode.

The operation may further include: setting the operation mode of the door to a closing mode if an event indicating that sale of the goods ends occurs; holding transmission of a door closing command until the moving object is not detected in the safety area if the operation mode is the closing mode and it is determined that the moving object exists in the safety area; transmitting the door closing command requesting closing of the door to the door controller if the operation mode is the closing mode and it is determined that the moving object does not exist in the safety area; and setting the operation mode of the door to a driving mode if the closing of the door is completed.

The operation may further include: transmitting a warning sound or displaying a warning on an external display device mounted on the vehicle if the operation mode of the door is set to the closing mode; and stopping transmission of the warning sound or display of the warning if the operation mode of the door is set to the driving mode.

A shock absorbing material may be formed at at least one corner of the door.

One or more non-transitory computer-readable media according to an example includes an instruction executable by a computing device. The instruction causes the computing device to perform an operation when executed by one or more processors of the computing device, and the operation includes setting an operation mode of a door to an opening mode if it is determined that a vehicle including a service area defined as a space where goods are displayed on one side surface thereof and the door that is opened or closed up and down through a hinge provided on an upper surface thereof to open or close the service area stops to reach a sale area selling the goods, reading information on a predefined safety area from a memory of the computing device, operating a sensor mounted on the vehicle to determine whether a moving object exists in the safety area based on the information on the safety area, transmitting a door opening command requesting opening of the door to a door controller if the operation mode is the opening mode and it is determined that the moving object does not exist in the safety area, and setting the operation mode of the door to a vehicle stop standby mode if the opening of the door is completed.

While this disclosure has been described in connection with what is presently considered to be practical examples, it should be understood that the disclosure is not limited to the disclosed examples, but, on the contrary, is intended to cover various modifications and equivalent arrangements included within the spirit and scope of the appended claims.

What is claimed is:

1. A method performed by an apparatus of a vehicle, the method comprising:
based on the vehicle reaching a designated location where the vehicle is configured to open a door of the vehicle to provide access for an object in the vehicle, setting an operation mode of the door to an opening mode;
obtaining, from a memory of the vehicle, information on a predefined safety space associated with the vehicle;
determining, using a sensor of the vehicle and based on the information on the predefined safety space whether a moving entity exists in the predefined safety space;
outputting, based on determining that no moving entity exists in the predefined safety space and the operation mode being the opening mode, a signal requesting opening of the door; and
changing, based on the opening of the door being completed, the operation mode of the door to a vehicle stop standby mode, in which the vehicle is configured to remain stationary with the door being opened to allow access to the object in the vehicle.

2. The method of claim 1, further comprising:
detecting, based on data obtained from the sensor, a current driving position of the vehicle;
obtaining, based on the current driving position of the vehicle, position information for the designated location from the memory; and
determining, based on the current driving position and the position information, whether the vehicle reaches the designated location, wherein the designated location is associated with an item transaction between the vehicle and an entity.

3. The method of claim 2, further comprising:
detecting, based on information on a surrounding environment of the vehicle obtained from the sensor, a predetermined type of object in the surrounding environment; and
determining, based on the detecting of the predetermined type of object, that the vehicle reaches the designated location.

4. The method of claim 1, wherein the information on the predefined safety space comprises a value representing a radius defined around a point of a service space of the vehicle via which the object in the vehicle is visually displayed on a side surface of the vehicle when the service space is not covered by the door, and wherein the door is configured to open to uncover at least a portion of the service space.

5. The method of claim 1, wherein the information on the predefined safety space comprises values representing a first radius and a second radius, wherein the first radius and the second radius are defined around a point of a service space of the vehicle in which the object in vehicle is displayed, and wherein the determining of whether the moving entity exists in the predefined safety space comprises:
based on a first object being located within the first radius and moving at or above a predetermined first speed, determining that the first object is the moving entity; and
based on a second object being located within the second radius and moving at or above a predetermined second speed, determining that the second object is the moving entity.

6. The method of claim 1, wherein the outputting of the signal comprises:
delaying the outputting of the signal until a detected moving entity in the predefined safety space disappears from the safety space.

7. The method of claim 1, further comprising:
outputting, based on the operation mode of the door being changed to the opening mode, a warning sound via a speaker of the vehicle or a warning message via an external display of the vehicle; and
stopping, based on the operation mode of the door being changed to the vehicle stop standby mode, the outputting of the warning sound or the warning message.

8. The method of claim 1, further comprising:
changing, based on an event indicating the access to the object in the vehicle ending, the operation mode of the door to a closing mode;
delaying, based on the operation mode of the door being the closing mode, outputting of a signal requesting closing of the door until a detected moving entity in the predefined safety space disappears from the safety space;
outputting, based on the detected moving entity in the predefined safety space disappearing from the safety space, the signal requesting the closing of the door; and
changing, based on the closing of the door being completed, the operation mode of the door to a driving mode.

9. The method of claim 8, further comprising:
outputting, based on the operation mode of the door being changed to the closing mode, a warning sound via a speaker of the vehicle or a warning message via an external display device of the vehicle; and
stopping, based on the operation mode of the door being changed to the driving mode, outputting of the warning sound or the warning message.

10. An apparatus of a vehicle, the apparatus comprising:
a processor; and
a memory storing at least one instruction that, when executed by the processor communicating with the memory, is configured to cause the apparatus to:
based on the vehicle reaching a designated location where the vehicle is configured to open a door of the vehicle to provide access to an object in the vehicle, set an operation mode of the door to an opening mode;
obtain, from a memory of the vehicle, information on a predefined safety space associated with the vehicle;
determine, using a sensor of the vehicle and based on the information on the predefined safety space, whether a moving entity exists in the predefined safety space;
output, based on determining that no moving entity exists in the predefined safety space and the operation mode being the opening mode, a signal requesting opening of the door; and
changing, based on the opening of the door being completed, the operation mode of the door to a vehicle stop standby mode, in which the vehicle is configured to remain stationary with the door being opened to allow access to the object in the vehicle.

11. The apparatus of claim 10, wherein the at least one instruction, when executed by the processor communicating with the memory, is configured to cause the apparatus to:
detect, based on data obtained from the sensor, a current driving position of the vehicle,
obtain, based on the current driving position of the vehicle, position information for the designated location from the memory, and
determining, based on the current driving position and the position information, whether the vehicle reaches the designated location, and wherein the designated location is associated with an item transaction between the vehicle and an entity.

12. The apparatus of claim 11, wherein the at least one instruction, when executed by the processor communicating with the memory, is configured to cause the apparatus to:
detect, based on information on a surrounding environment of the vehicle obtained from the sensor, a predetermined type of object in the surrounding environment, and
determine, based on the detection of the predetermined type of object, that the vehicle reaches the designated location.

13. The apparatus of claim 10, wherein the information on the predefined safety space comprises a value representing a radius defined around a point of a service space of the vehicle via which the object in vehicle is visually displayed on a side surface of the vehicle when the service space is not covered by the door, and wherein the door is configured to open to uncover at least a portion of the service space.

14. The apparatus of claim 10, wherein the information on the predefined safety space comprises values representing a first radius and a second radius, wherein the first radius and the second radius are defined around a service space of the vehicle in which the object in vehicle is displayed, and wherein the at least one instruction, when executed by the processor communicating with the memory, is configured to cause the apparatus to:
based on a first object being located within the first radius and moving at or above a predetermined first speed, determine that the first object is the moving entity, and
based on the second object being located within the second radius and moving at or above a predetermined second speed, determine that the second object is the moving entity.

15. The apparatus of claim 10, wherein a shock absorbing material is formed at at least one corner of the door.

16. An autonomous vehicle comprising:
a service compartment configured to accommodate and present an object for retrieval;
a door movably mounted to a side of the autonomous vehicle and configured to open to allow an access to the service compartment;
at least one sensor configured to detect a presence of an external entity in a predefined safety space within a threshold distance from the door; and
a processor circuit configured to:
determine whether the autonomous vehicle has reached a designated location associated with at least one operation of the service compartment,
detect, using the at least one sensor and based on the autonomous vehicle reaching the designated location, whether an external entity is present in the predefined safety space,
deactivate, based on a detection of the external entity in the predefined safety space, movement of the door, and
activate, based on the external entity not being present in the predefined safety space, movement of the door to cause opening of the door to allow access to the service compartment or cause closing of the door to prevent access to the service compartment.

17. The autonomous vehicle of claim 16, wherein the door is configured to open and close via a hinge disposed along an upper edge of the door, such that the door moves in a vertical direction relative to the autonomous vehicle.

18. The autonomous vehicle of claim 16, wherein the processor circuit is further configured to output, based on a detection of the external entity in the predefined safety space, a warning signal to at least one of an external display of the autonomous vehicle or an audio output device of the autonomous vehicle.

19. The autonomous vehicle of claim 16, wherein the designated location is a stop point associated with the retrieval of the object in the service compartment of the autonomous vehicle.

20. The autonomous vehicle of claim 16, wherein the predefined safety space comprises a first area within a first radius from the door and a second area within a second radius from the door, the second radius being greater than the first radius, and wherein the processor circuit is further configured to determine that the external entity is present in the predefined safety space by:
identifying, as the external entity, a first object located within the first radius and moving at or above a first threshold speed, and
identifying, as the external entity, a second object located within the second radius and moving at or above a second threshold speed, wherein the second threshold speed is greater than the first threshold speed.
